(19) United States
(12) Patent Application Publication
(10) Pub. No.: US 2011/0017078 A1
(43) Pub. Date: Jan. 27, 2011

(54) ENERGY SAVING COOKING SET

(75) Inventor: Kevin O'Connell, Manhattan Beach, CA (US)

Correspondence Address: SCHNECK & SCHNECK, P.O. BOX 2-E, SAN JOSE, CA, 95109-0005, US

(73) Assignee: CLIPPER CORPORATION, Carson, CA (US)

(21) Appl. No.: 12/507,001

(22) Filed: Jul. 21, 2009

(51) Int. Cl. A47J 37/10

(52) U.S. Cl. 99/448

(57) ABSTRACT

An energy efficient cooking set with separate cooking regions for diverse foods is disclosed. A cooking pan has a flat major surface surrounded by a perimeter side wall. A plate nests into the pan, with standoffs spacing the plate from the major surface of the pan. The plate has receiving areas, which may include slots and may include alignment protrusions. A first partition has projections which may include tabs. The projections fit into respective receiving areas on the plate. In an embodiment, a second partition has projections fitting into respective receiving areas on the plate. In a further embodiment; tabs on a lower edge of each partition insert into respective slots on the plate, removably affixing the partition perpendicularly to and spanning the plate. A selected partition divides the plate into separate cooking regions for simultaneously cooking separated foods in cooperation with the perimeter side wall.

### TECHNICAL FIELD

The present invention relates generally to energy saving cooking equipment and, more specifically, to cooking pans having a dividers for simultaneous preparation of diverse foods.

### BACKGROUND

Various cooking utensils have been devised for use with ovens and stoves. As energy conservation awareness increases, there is a need to find new cooking tools that save energy without loss of cooking efficiency.

U.S. Pat. No. 1,909,983, VEGETABLE COOKER, to Powell discloses a receptacle with perforated side walls and perforated bottom that allows simultaneous cooking of multiple foods in the same vessel. The metal receptacle has supporting legs and a vertically extending standard with a handle, and may be placed in a cooking pot or pan for steaming foods such as vegetables. A removable, three-winged partition drops past the standard, into the receptacle, and divides the receptacle into three compartments for cooking up to three separated vegetables simultaneously.

U.S. Pat. No. 5,069,198, FOOD STEAMING APPARATUS, to Henderson discloses a food steaming apparatus with circumferentially directed apertures to create a spiraling or swirling action in steam passing through the apertures. A removable, deflector zone accompanied, perforated three-walled divider separates food on the food supports. The apparatus allows simultaneous cooking of different foods.

UK Patent Application Publication No. GB 2340823 A, FOOD CONTAINERS, to Gade discloses a food container for a microwave oven. The food container has a horizontal separator with perforations dividing a receptacle into an upper and a lower compartment. Water or other liquid may be placed in the lower compartment. The container may be circular or rectangular. The separator rests on a supporting shelf in the receptacle and snaps into place beneath lugs. There are no partitions for separating food in compartments.

U.S. Patent Application Publication No. 2009/0095169 A1, ADAPTER FOR A SLOW COOKER, to York discloses an adapter for a slow cooker, having a tray fitting an upper rim of the cooker. A partition divides the tray into two regions for cooking separated food items side by side. The partition is molded as part of the tray and is not removable. The adapter may be made of glass, thermosetting plastic or ceramic.

Steam cooking usually employs an apparatus with apertures allowing passage of steam. Separation of foods during cooking may employ separate cooking vessels, a cooking vessel with a fixed divider or a removable three-winged or three-walled divider.

It is an object of the present invention to provide a cooking apparatus for use in diverse cooking methods and environments that saves energy by simultaneous cooking of different foods.

### SUMMARY

A versatile cooking set has been invented featuring partitions that change the shape and dimensions of a cooking region to allow simultaneous cooking of different foods. A cooking pan, having a flat major surface, with a plate elevated above a heated surface and surrounded by a perimeter side wall, may be used directly for cooking without any partition. However, the use of partitions fitting into the plate will separate foods to be cooked so that different foods can be cooked simultaneously.

The plate nests into the pan. Standoffs on a bottom face of the plate support the plate parallel to and spaced from the major surface of the pan. The plate has receiving areas for partitions. In an embodiment, the receiving areas of the plate include insertion slots for supporting food partitions and may have alignment protrusions. In an embodiment, the alignment protrusions include two blocks flanking each slot and projecting downwards from the bottom face of the plate to help provide support for partitions.

A first partition has projections fitting into respective receiving areas on the plate. In an embodiment, the projections include tabs. In a further embodiment, a second partition, with different dimensions from the first partition, has projections fitting into other respective receiving areas on the plate so that different partitions can define different cooking configurations. The first partition may have three tabs fitting into three lengthwise slots on the plate. The second partition may be shorter than the first partition and have two tabs fitting into two widthwise slots on the plate.

Each partition removably affixes perpendicularly to and spanning the plate, with the projections from the partition fitting into the respective receiving areas on the plate or with the tabs from the partition inserted into the respective slots on the plate. A selected partition divides the plate into separated cooking regions for cooking separated foods. The partition selectably divides the plate into different food cooking regions in cooperation with the perimeter side wall of the pan.

In an embodiment, the plate has fluid circulation apertures so that steam or juices can flow through the plate. In a further embodiment, circulation apertures are radially disposed on the plate. The apertures provide for circulation of air, liquid or vapor.

A handle may be part of the pan or be removably clippable or otherwise attachable to the pan. Pieces of the cooking set may be molded high temperature plastic, suitable for use in a conventional oven or a microwave oven. The plastic may be translucent or partially transparent, for viewing foods during cooking.

By using the pan without partitions, the pan with the nested plate or the pan with the nested plate and a selected partition affixed to the plate, the cooking set provides cooking regions of various shapes and dimensions.

### BRIEF DESCRIPTION OF THE DRAWINGS

FIG. 1 is a perspective view of an assembled cooking set, in accordance with an embodiment of the invention.

FIG. 2 is an exploded view of the cooking set of FIG. 1.

FIG. 3 is an elevational view of a first partition for the cooking set of FIG. 1.

FIG. 4 is an elevational view of a second partition for the cooking set of FIG. 1.

FIG. 5 is a perspective view of the partition of FIG. 3 assembled with the plate from the cooking set of FIG. 1.

FIG. 6 is a perspective view of the partition of FIG. 4, assembled with the plate from the cooking set of FIG. 1.

### DETAILED DESCRIPTION

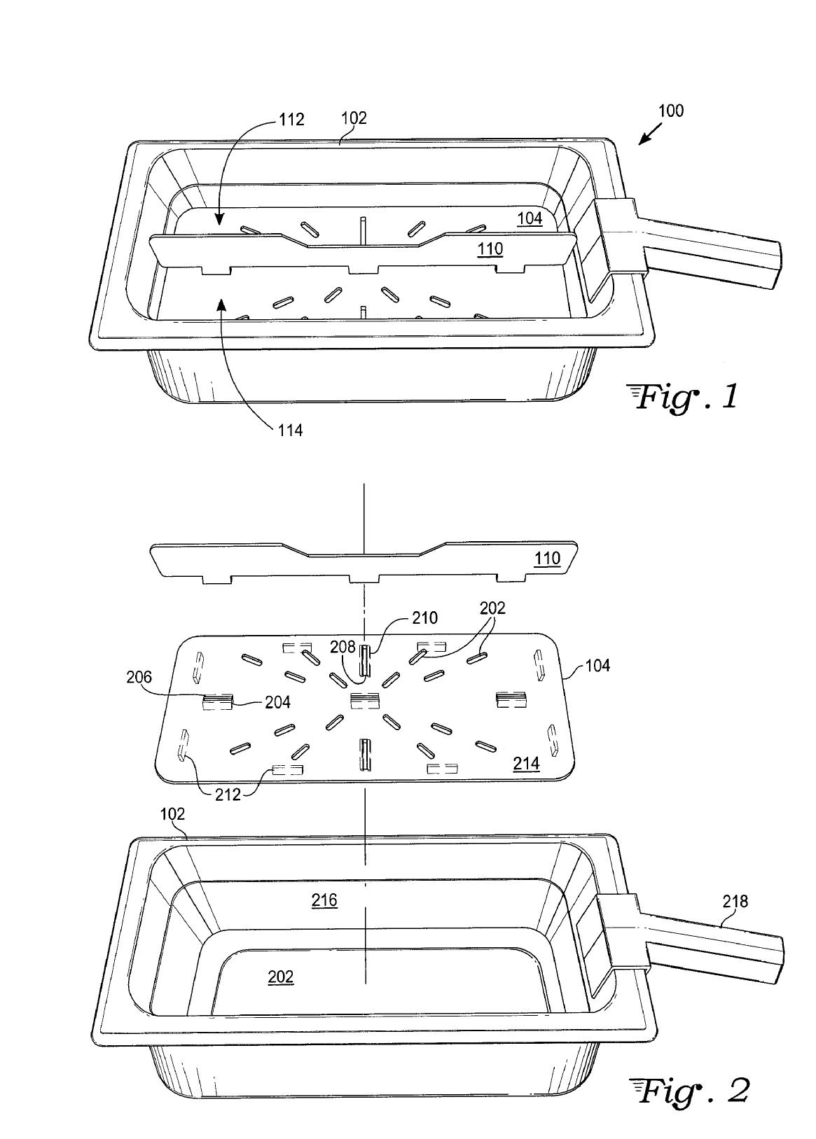

With reference to FIG. 1, an assembled cooking set 100, in accordance with an embodiment of the invention, is shown with separated food regions 112 and 114. A cooking pan 102 has a plate 104 which nests into the pan. A partition 110 divides the plate 104 into separated cooking regions 112 and 114.

With reference to FIG. 2, the pan 102 has a major surface 202 surrounded by a perimeter wall 216. The pan 102 is usable for cooking foods directly on the major surface 202, without partitions. A handle 218 is shown attached to the pan 102, for convenience during cooking. In a further embodiment, the pan is usable without a handle. The perimeter side wall 216 serves to contain foods or liquids in the pan in standard practice for cookware. Both the overall pan 102 and the major surface 202 have a rounded rectangular shape, although other shapes may be used.

With further reference to FIG. 2, the plate 104 has receiving areas 204 and 208, for receiving a partition. In a preferred embodiment, receiving area 204 includes three slots oriented lengthwise on the plate 104, for receiving a longer partition, and receiving area 208 includes two slots oriented widthwise on the plate 104, for receiving a shorter partition. Other quantities, arrangements and orientations of slots or receiving areas may be devised.

Alignment protrusions 206 and 210 (in phantom lines) are located next to receiving areas 204 and 208. In a preferred embodiment, alignment protrusions 206 and 210 include two blocks flanking each slot and projecting downwards from the bottom face of the plate 104. In further embodiments, alignment protrusions may be on either or both of the top face 214 or the opposing bottom face of the plate 104. Various shapes, placements and quantities of alignment protrusions may be devised by a person skilled in the art.

Standoffs 212 (in phantom lines) on the bottom face of the plate 104 support and space the plate 104 from the major surface 202 of the pan 102, as shown in FIG. 1. The plate 104 is maintained close to and parallel to the major surface 202 of the pan 102. Various shapes and locations for the standoffs may be devised by a person skilled in the art. The rounded rectangular outline and shape of the plate 104 follow the outline and shape of the major surface 202 of the pan 102, allowing for a nested fit of the plate 104 within the pan 102, although other outlines and shapes could be used for either or both of the plate and the pan.

Returning to FIG. 2, the plate 104 is shown with circulation apertures 202. Apertures 202 in the plate 104 are radially disposed, but may be oriented in a further direction or pattern devised by a person skilled in the art. Apertures 202 allow circulation of air, liquid or vapor, such as steam, during cooking.

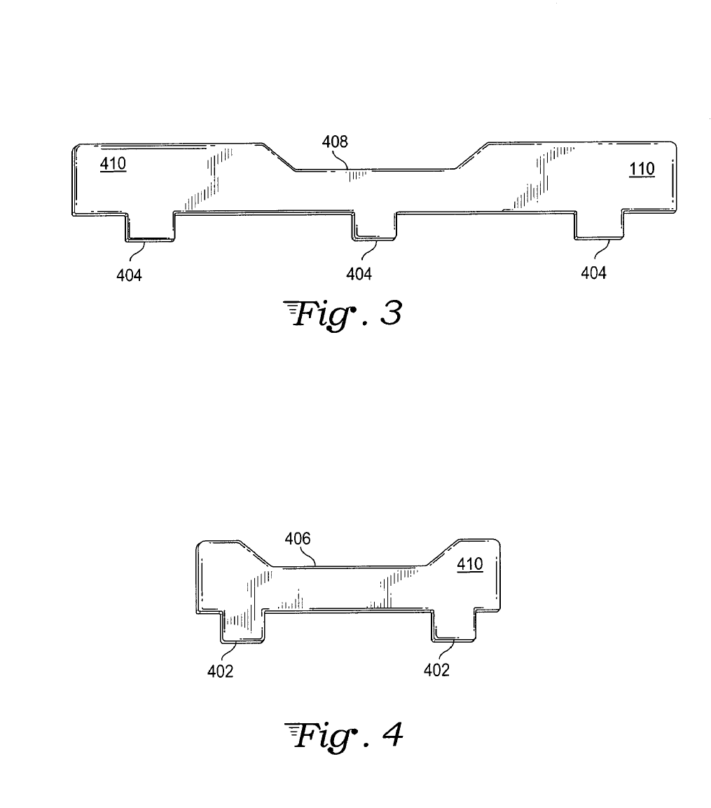

With reference to FIGS. 3 and 4, a first partition 110 and a second partition 410 are shown. The first partition 110 has projections 404, embodied as three tabs, and the second partition 410 has projections 402, embodied as two tabs. Projections such as tabs, along a lower edge of a partition, fit into respective receiving areas, such as slots, in the plate. Other projections and receiving areas may be devised by a person skilled in the art.

In order to arrange different food cooking regions, one of the partitions may be selected and fitted onto the plate. The selected partition divides the plate into different food cooking regions in cooperation with the perimeter side wall 216 of the pan 102, as shown in FIGS. 1 and 2.

Partitions may have various shapes. In a preferred embodiment as shown in FIG. 4, a partition 110 or 410 has a widened or elongated, flat-bottomed notch 408 or 406 in the top edge of the partition. Each of the partitions is taller at opposing ends than at the center of the partition, allowing air or vapor circulation during cooking. A flat-topped edge, without a notch, may also be used on a partition.

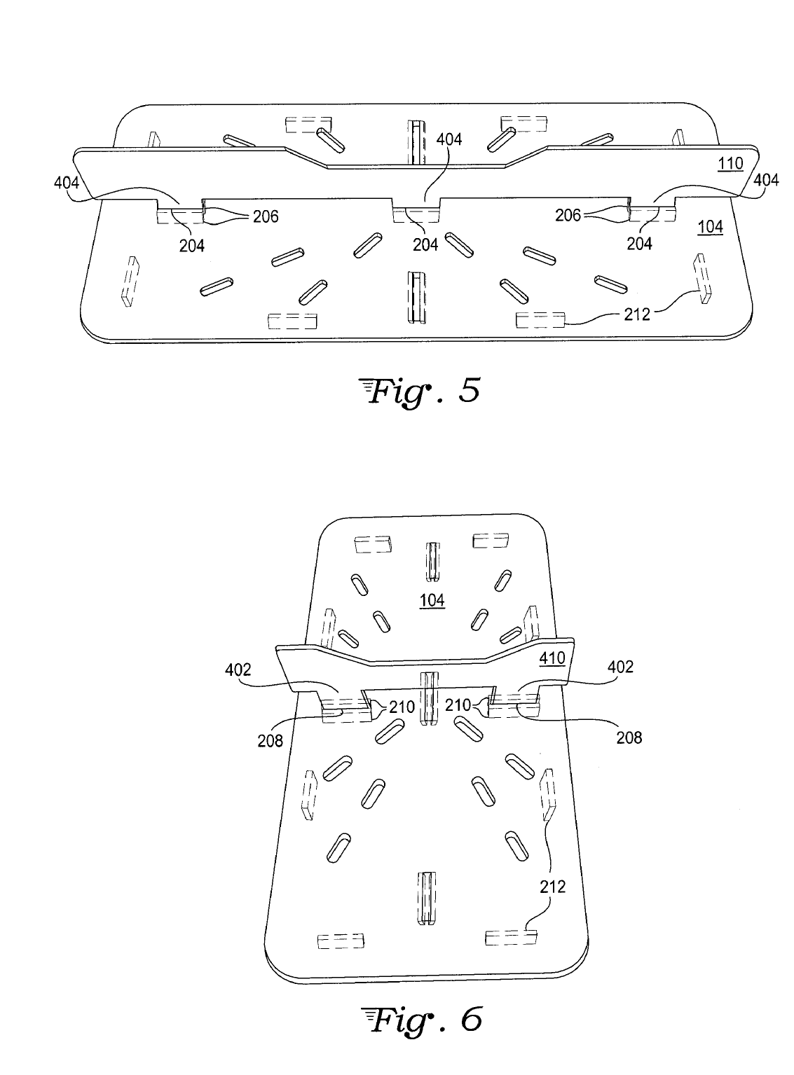

With reference to FIG. 5, partition 410 is affixed perpendicularly to and spanning the plate 104, dividing the plate 104 into separate regions for cooking separated foods. Tabs as projections 404 from partition 410 fit into slots as receiving areas 204 on the plate 104. The alignment protrusions 206 guide and stabilize the tabs while and after the tabs are inserted into the respective slots. Partition 110, being longer than partition 410, fits lengthwise on the pan 104.

With reference to FIG. 6, partition 110 is affixed perpendicularly to and spanning the plate 104, dividing the plate 104 into separate regions for cooking separated foods. Tabs as projections 402 from partition 110 fit into slots as receiving areas 208 on the plate 104. The alignment protrusions 210 guide and stabilize the tabs while and after the tabs are inserted into the respective slots. Partition 410, being shorter than partition 110, fits widthwise on the pan 104.

In an embodiment shown in FIG. 2 and discussed with reference thereto, the alignment protrusions 206 and 210 of the plate 104 include two alignment blocks proximate to each slot 204 and 208. The alignment protrusions or blocks guide a respective projection or tab, from a partition, being inserted into the slot, and stabilize the projection or tab being so inserted. The alignment protrusions firmly sandwich the projection during and after insertion, directing and gripping the projection. The alignment protrusions proximate to each slot thus perform an alignment function and support for the projections of the partition and the partition itself. The affixed partition remains stable and aligned upon the plate, as shown in FIGS. 1, 5 and 6, because the alignment protrusions resist lateral displacement of the partition and resist removal of the partition. The plate 104 is nested within the pan 102, with the bottom face of the plate 104 facing the major surface 202 of the pan 102, before or after the selected partition is affixed.

Various materials may be used in manufacturing the pieces of the cooking set. In a preferred embodiment, the pan, the plate, the partitions and the handle are molded high temperature plastic suitable for use in a conventional oven or a microwave oven. In a further embodiment, the high temperature plastic is translucent or partially transparent so that food in the cooking set is visible through the glass in the door of a conventional oven or microwave oven.

With reference to FIGS. 1, 2, 5 and 6 a method for using a cooking set in accordance with an embodiment of the invention is herein described. If using the pan 102 without any partitions and without the plate, place food and any liquid desired into the pan and proceed to cook. If using the pan 102 with the plate 104 and no partitions, nest the plate 104 into the pan 102. Place food and any liquid desired into the pan, the food remaining on the plate, and proceed to cook. If using the pan 102 with a partition, select a long partition 410 or a short partition 110. Insert the tabs or protrusions from the partition into the respective slots or receiving areas on the plate 104, dividing the plate 104 into separate regions for cooking separated foods. Nest the plate 104 into the pan 102, resting the standoffs 212 of the plate 104 on the major surface 202 of the pan 102, supporting and spacing the plate 104 from and parallel to the major surface 202 of the pan 102. The selected partition, in cooperation with the perimeter side wall 216 of the pan 102, divides the plate 104, the pan 102, and the assembled cooking set into separated cooking regions. Exchanging the selected partition for a further partition, or removing the partition, changes the dimensions and the shape of the cooking regions for flexibility in cooking different foods in the same pan 102. Place food into each of the separated cooking regions, add water for steam cooking or any other liquid desired into the pan 102, and place the pan 102 into a heated region for cooking.

The objects of the invention are achieved by providing a cooking set which can be used with the pan alone, the pan and the plate, or the pan, the plate and a selected partition assembled. Exchanging partitions or removing a partition changes the dimensions and shape of the cooking regions, for different sizes and shapes of foods to be cooked. Manufacturing the pieces of the cooking set with a high temperature plastic suitable for use in a conventional oven or a microwave oven allows the flexibility of use in different cooking techniques and environments. Apertures in the plate allowing circulation give versatility to the cooking set, which can be used for dry cooking while draining liquids, steam cooking, parboiling, commingling liquids from adjacent foods and other cooking methods.

What is claimed is:

1. An energy saving cooking set comprising:
a pan having a major surface;
a plate nesting into the pan and having a plurality of receiving areas and a plurality of standoffs spacing the plate from the major surface; and
a first partition, having a plurality of projections fitting into respective receiving areas on the plate and dividing the plate into separated cooking regions.

2. The cooking set of claim 1 further comprising a second partition having a plurality of projections fitting into respective receiving areas on the plate and dividing the plate into separated cooking regions.

3. The cooking set of claim 2 wherein the first partition is longer than the second partition.

4. The cooking set of claim 1 wherein:
the plurality of projections of the first partition includes a tab; and
the plurality of receiving areas includes a slot.

5. The cooking set of claim 1 further comprising alignment protrusions proximate to each receiving area.

6. The cooking set of claim 1 wherein the plate has apertures for circulation.

7. An energy saving cooking set comprising:
a pan having a major surface and a perimeter side wall;
a plate having standoffs, insertion slots and circulation apertures and nesting into the pan proximate and parallel to the major surface; and
a first and a second partition, each having a plurality of tabs fitting into respective insertion slots on the plate and selectably dividing the plate into different food cooking regions in cooperation with said perimeter side wall.

8. The cooking set of claim 7 wherein the first partition has three tabs and the plate has three lengthwise slots.

9. The cooking set of claim 7 wherein the second partition has two tabs and the plate has two widthwise slots.

10. The cooking set of claim 7 wherein the circulation apertures are radially disposed.

11. The cooking set of claim 7 wherein each insertion slot has two alignment blocks.

12. The cooking set of claim 7 wherein the standoffs support the plate spaced from the major surface of the pan.

13. The cooking set of claim 7 further comprising a handle removably attachable to the pan.

14. An energy saving cooking set comprising:
a cooking pan having a flat major surface surrounded by a perimeter wall;
a plate nestable in the cooking pan having apertures for air, liquid or vapor circulation, slots with alignment protrusions and a bottom face with standoffs spacing the plate from the major surface;
a plurality of partitions, each having a lower edge with a plurality of tabs and removably affixing perpendicularly to and spanning the plate, with the tabs inserted into the respective slots, the alignment protrusions guiding and stabilizing the tabs; and
a selected partition dividing the plate into separate regions for cooking separated foods.

15. The cooking set of claim 14 wherein the plurality of partitions includes a first partition with three tabs and a second partition with two tabs.

16. The cooking set of claim 14 wherein the alignment protrusions include two blocks flanking each slot and projecting downwards from the bottom face.

17. The cooking set of claim 14 further comprising the plate having a plurality of radially disposed apertures.

18. The cooking set of claim 14 wherein each of the plurality of partitions is taller at opposing ends than at a center of the partition.

19. The cooking set of claim 14 wherein the pan, the plate, and the plurality of partitions are molded plastic suitable for use in a microwave oven.

20. The cooking set of claim 14 further comprising a handle removably clippable to the pan.
